(19) United States
(12) Patent Application Publication
(10) Pub. No.: US 2026/0186955 A1
(43) Pub. Date: Jul. 2, 2026

(54) ERROR VALIDATOR AND NAVIGATOR

(71) Applicant: Rakuten Symphony, Inc., Tokyo (JP)

(72) Inventor: Vibhu PANDEY, Karnataka (IN)

(73) Assignee: Rakuten Symphony, Inc., Tokyo (JP)

(21) Appl. No.: 19/004,770

(22) Filed: Dec. 30, 2024

(51) Int. Cl. G06F 11/3698

(52) U.S. Cl. CPC G06F 11/3698

(57) ABSTRACT

A method, apparatus, and system for error validation and navigation may be provided and may include, receiving, by an error validation and navigation component, input data from a consumer component that is subscribed to the error validation and navigation component; evaluating, by the error validation and navigation component based on the input data, whether a field of the consumer component has an error or not; and sending, by the error validation and navigation component, a signal to the consumer component comprising instructions to render an error visualization component in the consumer component based on the evaluation and the input data, wherein the error visualization component includes a field highlighting component and a navigation bar component.

### FIELD

The present disclosure relates to error validation and navigation.

### BACKGROUND

The information disclosed in this background section is only for enhancement of understanding of the general background of the disclosure and should not be taken as an acknowledgement or any form of suggestion that this information forms the prior art already known to a person skilled in the art.

In the related art, it may be typical for a user interface including field/form input (for example, a webpage having a module for user entry), to have requirements on what data can be entered. To this end, the user interface may be configured to validate whether the data that is input into the field/form by the user is valid or not.

### SUMMARY

Related art methods may typically have to configure these features manually for each page/module in the user interface, which can be tedious and may be prone to errors. Furthermore, even if they can configure error validation for the user interface, it may not be consistent across all projects which the UI developer is managing.

Accordingly, there is a need for a modularized error validator and navigation component.

According to embodiments, a method for error validation and navigation may be provided and may include receiving, by an error validation and navigation component, input data from a consumer component that is subscribed to the error validation and navigation component; evaluating, by the error validation and navigation component based on the input data, whether a field of the consumer component has an error or not; and sending, by the error validation and navigation component, a signal to the consumer component including instructions to render an error visualization component in the consumer component based on the evaluation and the input data, wherein the error visualization component includes a field highlighting component and a navigation bar component.

Based on the above embodiments, functional operation of the error validator and navigator module may be uniform across all projects of the UI developer. This may allow the UI developer to focus on the actual design of the UI, rather than having to consider how to consistently implement error validation and navigation for each project individually

According to embodiments, an error validation and navigation component may be provided and may be configured to: receive input data from a consumer component that is subscribed to the error validation and navigation component; evaluate, based on the input data, whether a field of the consumer component has an error or not; and send a signal to the consumer component including instructions to render an error visualization component in the consumer component based on the evaluation and the input data, wherein the error visualization component includes a field highlighting component and a navigation bar component.

According to embodiments, at least one non-transitory computer-readable recording medium having recorded thereon instructions executable to implement a method may be provided, the method including: receiving, by an error validation and navigation component, input data from a consumer component that is subscribed to the error validation and navigation component; evaluating, by the error validation and navigation component based on the input data, whether a field of the consumer component has an error or not; and sending, by the error validation and navigation component, a signal to the consumer component including instructions to render an error visualization component in the consumer component based on the evaluation and the input data, wherein the error visualization component includes a field highlighting component and a navigation bar component.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a system architecture diagram for an error validation and navigation component and a consumer component, according to an embodiment;

FIG. 2 illustrates a block diagram of a method for rendering an error visualization component according to an embodiment;

FIG. 3 illustrates an example user interface for visualizing the errors according to an embodiment;

FIG. 4 is a diagram of an implementation environment in which systems and/or methods, described herein, may be implemented; and

FIG. 5 is a diagram of example components of a device according to an embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

According to embodiments, a method, apparatus, and system for error validation and navigation may be provided. Example embodiments of the present invention may provide a error validator and navigator module. The module may be configured such that it can be included in a user interface without further reconfiguration of the module for the specific user interface, such that the functional operation of the error validator and navigator module may be uniform across all projects of the UI developer. This may allow the UI developer to focus on the actual design of the UI, rather than having to consider how to consistently implement error validation and navigation for each project individually.

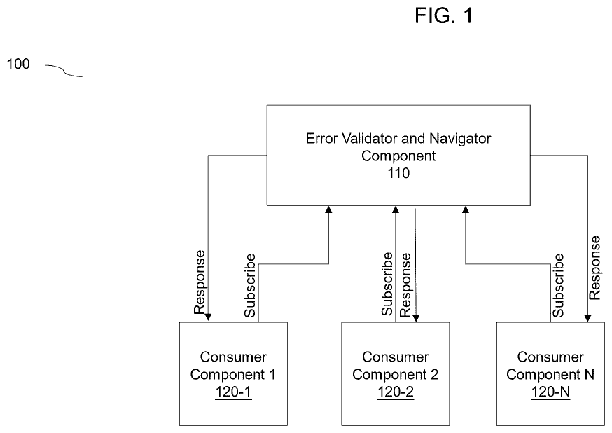

FIG. 1 illustrates a system architecture diagram for system 100 having an error validator and navigation component 110 and consumer components 120-1, 120-2, 120-N, according to an embodiment.

Error validation and navigation component 110 is configured to provide processing for validating whether a field of a user interface in consumer components 120-1, 120-2, 120-N has an error, and also provide navigation between said fields. Consumer components 120-1, 120-2, 120-N may be separate components from error validator and navigation component 110, according to an embodiment. Consumer components 120-1, 120-2, 120-N may be configured to implement a user interface, which may include data entry fields (e.g., a text box, a checkbox, a dropdown box, etc.), nevertheless, it should be appreciated that the consumer components can encompass any appropriate interface which interacts with a consumer. As illustrated in FIG. 1, a given consumer component (e.g., 120-1) can “subscribe” to error validation and navigation component 110. That is, since the functionality of the error validation and navigation component 110 is not contained within a given consumer component (e.g., 120-1), the consumer component may opt to subscribe to the features contained within error validation and navigation component 110. In response, the error validation and navigation component 110 may provide a response to the consumer module. The response may be in the form of a message containing data, a signal, or some other appropriate means of communication.

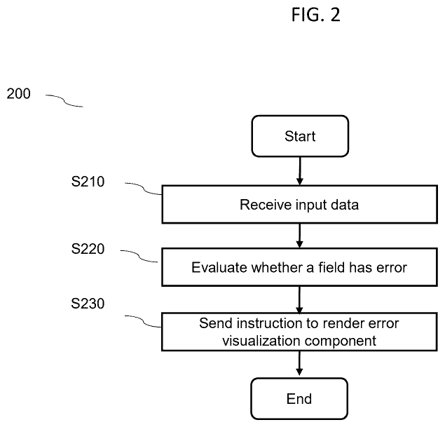

FIG. 2 illustrates a block diagram of a method 200 for rendering an error visualization component according to an embodiment.

Referring to FIG. 2, at operation S210, input data may be sent from a consumer component (e.g., 120-1) which is subscribed to error validation and navigation component 110, and received by error validation and navigation component 110. It should be appreciated that in some embodiments, operation S210 may also occur when the consumer component is subscribing to error validation and navigation component 110 for the first time. The input data may include a rendering parameter, which indicates whether an error visualization component should be rendered or not (e.g., if the value of the parameter is false, it is not rendered, and if it is true, it may be rendered). According to some embodiments, if the rendering parameter is set to false, error validation and navigation component 110 may not be activated in the first place at all.

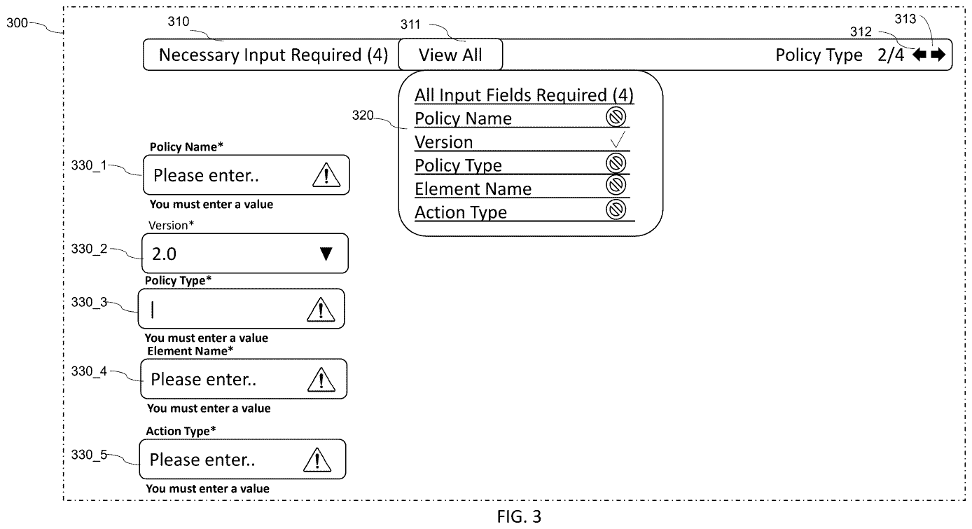

The input data may include form validation data. The form validation data may be used in order to instruct the error validation and navigation component 110 as to which field in the consumer component to select and verify for errors. According to some embodiments, the form validation data may comprise a field identifier, a field name, an error parameter which can either have a value of true or false, and an error message parameter, nevertheless it should be appreciated that more or less parameters may be included to further specify which field is selected, and how to configure said field when being subscribed to the error validation and navigation component 110. The field identifier may be used to identify the specific field being subscribed to. The field name may be the name/label of the field which is rendered in the detailed summary of the error visualization component (this can be seen in FIG. 3 described below). The error parameter indicates whether the error exists or not (e.g., if it is false, then the error does not exist, and if it is true, the error exists).

The input data may also include a form group identifier. Specifically, according to some embodiments, a consumer component may have one or more form group identifiers for different groups of fields (for example, a user interface in the consumer component may have a first form group dedicated towards entering a user's personal information, and a second form group dedicated towards entering a user's desired configuration settings). When provided with the form group identifier, the navigation portion of the error validation and navigation component 110 may be able to interpret a list of fields contained within a specific form group, and accordingly readily allow a user to navigate between fields which have errors in the consumer component.

Referring back to FIG. 2, at operation S220, based on the input data received in FIG. 1, error validation and navigation component may evaluate whether there is an error or not in a field. According to some embodiments, this may be achieved by evaluating the error parameter from the form validation data in the input data.

At operation S230, based on whether there is an error or not as evaluated in operation S220, as well as on the input data, the error validation and navigation component 110 may send an instruction to the subscribed consumer component to render an error visualization component. In particular, the error visualization components includes user interface (UI) elements which can be seen by a user. According to an embodiment, the error visualization component may include a field highlighting component, and a navigation bar component. The field highlighting component may be configured to highlight each field which has an error and display an error message next to each field which has an error, for example based on the error message parameter from the input data, and the navigation bar component may include a short summary describing how many errors there are, a detailed summary describing the status of all fields including which field has an error, and one or more navigation buttons, wherein the one or more navigation buttons may be configured to move a user's focus (e.g., their cursor) between fields which have errors (details regarding the error visualization component will be described in detail with reference to FIG. 3 further below).

In particular, if there is no error determined in operation S220, then the error visualization component may not be rendered for that particular field of the consumer component. If there is an error determined in operation S220 but the settings indicated in the input data (e.g., the rendering parameter) is set to false, then it may not be rendered for that particular field of the consumer component. If there is an error determined in operation S220 and the rendering parameter is set to true, then the appropriate portions of the error visualization component (e.g., the field highlighting component and the navigation component) may be updated.

It should be appreciated that the steps in method 200 may be triggered based on a user input. In particular, each time a user input is detected, all of the steps operation S210, S220, and S230, may be repeated in sequence for each field in the consumer component in order to check whether there is still any error (e.g., so as to check whether the user has rectified the error). In some embodiments, operation S210 may receive the input data each time a user's input is detected in the consumer component.

FIG. 3 illustrates an example user interface 300 which illustrates a consumer component which is subscribed to error validation and navigation component 110, according to an embodiment. It should be appreciated that the specific implementation (e.g., placement, size, shape of components, number of buttons, etc.) of the user interface may vary according to a person skilled in the art.

Referring to FIG. 3, navigation bar 310 is provided. As illustrated, the short summary indicates that there are 4 fields which require input. It may also indicate the current field with an error which the user is attempting to edit (e.g., “Policy Type”), along with which field they are on relative to the total number of errors (e.g., “2/4”). Navigation bar 310 may be updated based on the rendering instruction sent by error validation and navigation module in operation S230 above, and may be configured based on the navigation bar component mentioned above.

A button 311 may be included in the navigation bar 310, so as to display a detailed summary 320 when clicked (for example, by means of a dropdown box, rendering an overlay, or any other appropriate method).

One or more navigation buttons 312, 313 may be provided in the navigation bar 310, so as to allow a user to navigate between fields which have errors. For example, by interacting with a forward navigation button 313, the user's focus (e.g., their cursor, which is currently on field 330_3) may be advanced to the next field in the field group which contains an error (e.g., field 330_4). This may specifically be a field which shares the field group identifier, and has an error parameter of true, with reference to the input data. Conversely, if the backward navigation button 312 is interacted with, the user's focus (e.g., their cursor, which is currently on field 330_3) may be moved to the previous field in the field group which contains an error (e.g., field 330_1). Nevertheless, it should be appreciated that more, or less buttons may be used to allow the user to navigate (for example, only forward navigation button 313 could be included).

Detailed summary 320 may be provided in order to allow a user to see specifically which fields have errors or not, without looking at the entire form in the consumer component. The field names provided in the input data as received in operation S210 may be used for the name to display in detailed summary 320, and the error parameter may be used to indicate whether there is an error or not. As illustrated in FIG. 3, fields “policy name”, “policy type”, “element name”, and “action type” currently have an error, and have an error icon displayed, whereas “version” field had an error resolved or does not contain any error, and has a checkmark icon displayed. It should be appreciated that the specific configuration of how detailed summary 320 shows the field names and whether there is an error or not may have different implementations than what is illustrated, according to embodiments. It should also be appreciated that according to some embodiments, the error message from the input data received in operation S210 can be included in the detailed summary 320.

Fields 330_1, 330_2, 330_3, 330_4, 330_5 are provided. In the illustrated example in FIG. 3, Fields 330_1, 330_3, 330_4, 330_5 have an error, whereas field 330_2 does not have an error. The fields may have a default value (for example, “Please enter...”) to indicate that the user has not yet edited the field yet. When the user's focus (e.g., their cursor) is on a field (as illustrated in FIG. 3, the user's cursor is currently on 330_3), the default value may be hidden. Although textbox fields (e.g., 330_1, 330_3, 330_4, 330_5) and a dropdown box field (e.g., 330_2) are illustrated in FIG. 3, it should be appreciated that the fields may be other types of fields (such as a checkbox, radio box, a slider, etc.) may be implemented. Field highlighting component is activated and rendering for fields 330_1, 330_3, 330_4, and 330_5. Specifically, the field highlighting component may make the text and the field border more bold, change the color, change the style, add an alert icon, etc, whereas field 330_2 does not have these visual changes. It should be appreciated that the field highlighting component may render different appearances for different types of fields, and that a variety of visualization methods can be applied for highlighting a field.

The above embodiments may accordingly provide a method and device for ensuring that the functional operation of the error validator and navigator module may be uniform across all projects of the UI developer. This may allow the UI developer to focus on the actual design of the UI, rather than having to consider how to consistently implement error validation and navigation for each project individually.

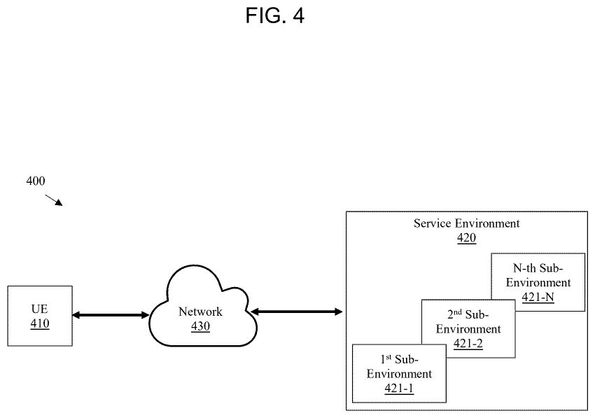

FIG. 4 is a diagram of an example of implementation environment 400 in which systems and/or methods, described herein, may be implemented. The implementation environment 400 includes a UE (User equipment) 410, a service environment 420, and a network 430. The service environment 420 include one or more sub-environments 421. To illustrate this, FIG. 4 shows, for convenience, examples of a 1st sub-environment 421-1, a 2nd sub-environment 421-2, and an N-th sub-environment 421-N (where N is any natural number).

The UE 410 is connected to the network 430, and the network 430 is connected to the service environment 420. The connections may be wired, wireless, or a combination of both wired and wireless. The UE 410 and the service environment 420 are connected via the network 430.

The UE 410 is a device that communicates with the service environment 420. The UE Δ10 receives information from the service environment 420 and/or sends information to the service environment 420. Also, the UE 410 may generate and/or store information to be transmitted, as necessary. Also, the UE 410 may store and/or process information that is received, as necessary.

The example FIG. 4 refers to the “UE”. However, it should be understood by those skilled in the art that general terms such as “user device,” “terminal,” “terminal device,” “communication device,” and “communication terminal” can be used interchangeably with the term “UE.”

For example, the UE 410 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 420 is an environment that communicates with the UE 410 to provide one or more services. The service environment 420 receives information from the UE 410 and/or sends information to the UE 410. Also, the service environment 420 may generate and/or store information to be transmitted, as necessary. Also, the service environment 420 may store and/or process information that is received, as necessary. For example, the service environment 420 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 4 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 420 is not specifically limited and can be adjusted according to the embodiments. For example, the services may include a service that provides information to the UE 410, a service that stores information from the UE 410, or a service that performs processing based on information from the UE 410 and returns the results of the processing.

In an embodiment, the Service Environments 420 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 420 includes one or more devices, such as servers and network devices, which provide services or perform processes. The placement of these devices within the service environment 420 can be determined as appropriate. Additionally, if the service environment 420 includes one or more sub-environments 421, the placement of devices can be determined based on predetermined policies for each sub-environment 421. For example, devices related to the first service may be placed in the 1st sub-environment 421-1, and devices related to the second service may be placed in the 2nd sub-environment 421-2. In another example, devices expected to have a higher load than a predetermined threshold may be placed in the 1st sub-environment 421-1, while devices expected to have a lower load than the predetermined threshold may be placed in the 2nd sub-environment 421-2. In this way, specific devices can be placed in specific sub-environments 421. Conversely, each sub-environment 421 can be specialized for a particular purpose.

In an embodiment, all processes executed in a single service may run within a single service environment, or in multiple service environments. Multiple processes executed in a single service could be provided by different service environments.

The network 430 is a network that exchanges information between the UE 410 and the service environment 420. The network 430 includes one or more wired and/or wireless networks.

For example, the network 430 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 430 can be a part of a network. For example, in a 5G network that includes a RAN, a transport network, and a core network, the network 430 can be at least one of the RAN, the transport network, or the core network. For example, the service environment 420 could be in the core network, in which case the network 430 could correspond to a network that is a combination of a RAN and a transport network and is part of the 5G network.

The number and arrangement of devices and networks shown in FIG. 4 are provided as an example. It should be understood that any changes that may be implemented by those skilled in the art, such as the addition or rearrangement of well-known devices or networks at the time of implementation, are included in this disclosure.

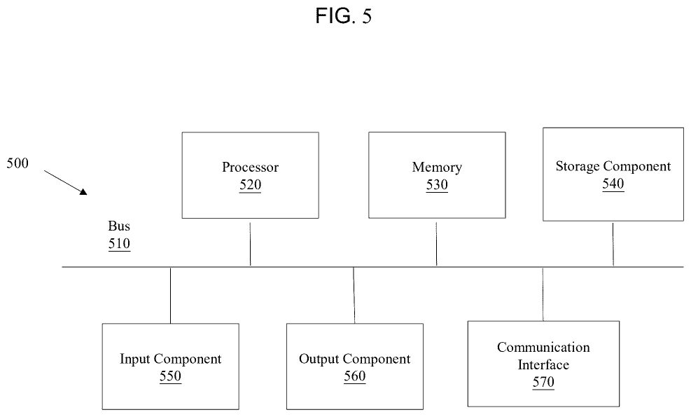

FIG. 5 illustrates an embodiment of a device 500. As shown in FIG. 5, the device 500 includes processor 510, a memory 520, a storage component 530, an input component 540, an output component 550, a communication interface 560, and a bus 570.

The processor 510, as used herein, means any type of computational circuit that may comprise hardware elements and software elements. The processor 510 may be embodied as a multi-core processor, a single core processor, or a combination of one or more multi-core processors and/or one or more single core processors, a distributed processing system, or the like. The processor 510 may be a Central Processing Unit (CPU), a graphics processing unit (GPU), an accelerated processing unit (APU), an application-specific integrated circuit (ASIC), or another type of processing component.

Memory 520 includes a non-transitory computer readable medium. Memory 520 includes a random-access memory (RAM), a read only memory (ROM), and/or another type of dynamic or static storage device (e.g., a flash memory, a magnetic memory, and/or an optical memory) that stores information and/or instructions for use by processor 510. The memory 520 comprises machine-readable instructions which are executable by the processor 510. These machine-readable instructions when executed by the processor 510 cause the processor 510 to perform one or more method steps of an embodiment described above.

Storage component 530 stores information and/or software related to the operation and use of the device 500. For example, storage component 530 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 540 is configured to receive information, such as user input. For example, the input component 540 may include, but not be limited to, a touch screen display, a keyboard, a keypad, a mouse, a button, a switch, and/or a microphone. Additionally, or alternatively, the input component 540 may include a sensor for sensing information (e.g., a global positioning system (GPS), an accelerometer, a gyroscope, and/or an actuator).

Output component 550 is configured to provide output information from the device 500. For example, the output component 550 may be, but not limited to, a display, a speaker, an instruction device to an external device, and/or one or more light-emitting diodes (LEDs).

Communication interface 560 is an interface that provides a communication connection to other devices, such as external devices and internal devices. The connection by the communication interface 560 can be a wired connection, a wireless connection, or a combination of wired and wireless connections, and can be a direct connection or an indirect connection via a communication network that exists between the device 500 and other devices. In other words, the standard of the communication interface 560 is not limited.

The bus 570 acts as an interconnect between the processor 510, the memory 520, the storage component 530, the input component 540, the output component 550, and the communication interface 560 of the device 500. The bus 570 may include a wired interconnection or a wireless interconnection.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500. Further, one or more method steps described in any of the embodiments may be performed utilizing a plurality of devices 500 in communication with one another.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Various further respective aspects and features of embodiments of the present disclosure may be defined by the following items:
Item [1]. A method including receiving, by an error validation and navigation component, input data from a consumer component that is subscribed to the error validation and navigation component; evaluating, by the error validation and navigation component based on the input data, whether a field of the consumer component has an error or not; and sending, by the error validation and navigation component, a signal to the consumer component including instructions to render an error visualization component in the consumer component based on the evaluation and the input data, wherein the error visualization component includes a field highlighting component and a navigation bar component.
Item [2]. The method according to item [1], wherein the field highlighting component is configured to highlight each field which has an error and display an error message next to each field which has an error, and wherein the navigation bar includes a short summary describing how many errors there are, a detailed summary describing the status of all fields including which field has an error, and one or more navigation buttons, wherein the one or more navigation buttons are configured to move a user's focus between fields which have errors.
Item [3]. The method according to any one of items [1]-[2], wherein the input data is received each time a user's input is detected in the consumer component.
Item [4]. The method according to any one of items [1]-[3], wherein the input data further includes a rendering parameter which can either have a value of true or false, wherein if the value of the rendering parameter is false, the error visualization component is not rendered.
Item [5]. The method according to item [2], wherein the input data further includes form validation data and a form group identifier, wherein the field is selected based on the form validation data and the form group identifier, and wherein evaluating whether the field of the consumer component has an error or not is based on the form validation data.
Item [6]. The method according to item [5], wherein the form validation data includes a field identifier, a field name, an error parameter which can either have a value of true or false, and an error message parameter, wherein the field of the consumer component is one which matches the field identifier; wherein the field name is rendered in the detailed summary; wherein if the value of the error parameter is true, the field highlighting component is activated for the field and the status of the field in the detailed summary indicates there is an error; wherein if the value of the error parameter is false, the field highlighting component is deactivated for the field and the status of the field in the detailed summary indicates that there is no error; and wherein the displayed error message is based on the error message parameter.
Item [7]. The method according to item [6], wherein the one or more navigation buttons are configured to move a user's focus between fields which belong to the form group identifier and the value of the error parameter for each field of the fields is true.
Item [8] An error validation and navigation component configured to: receive input data from a consumer component that is subscribed to the error validation and navigation component; evaluate, based on the input data, whether a field of the consumer component has an error or not; and send a signal to the consumer component including instructions to render an error visualization component in the consumer component based on the evaluation and the input data, wherein the error visualization component includes a field highlighting component and a navigation bar component.
Item [9] The error validation and navigation component according to Item [8], wherein the field highlighting component is configured to highlight each field which has an error and display an error message next to each field which has an error, and wherein the navigation bar includes a short summary describing how many errors there are, a detailed summary describing the status of all fields including which field has an error, and one or more navigation buttons, wherein the one or more navigation buttons are configured to move a user's focus between fields which have errors.
Item [10] The error validation and navigation component according to any one of Items [8]-[9], wherein the input data is received each time a user's input is detected in the consumer component.
Item [11] The error validation and navigation component according to any one of Items [8]-[10], wherein the input data further includes a rendering parameter which can either have a value of true or false,
   wherein if the value of the rendering parameter is false, the error visualization component is not rendered.
Item [12] The error validation and navigation component according to Item [9], wherein the input data further includes form validation data and a form group identifier,
   wherein the field is selected based on the form validation data and the form group identifier, and wherein evaluating whether the field of the consumer component has an error or not is based on the form validation data.
Item [13] The error validation and navigation component according to Item [12], wherein the form validation data includes a field identifier, a field name, an error parameter which can either have a value of true or false, and an error message parameter, wherein the field of the consumer component is one which matches the field identifier; wherein the field name is rendered in the detailed summary; wherein if the value of the error parameter is true, the field highlighting component is activated for the field and the status of the field in the detailed summary indicates there is an error; wherein if the value of the error parameter is false, the field highlighting component is deactivated for the field and the status of the field in the detailed summary indicates that there is no error; and wherein the displayed error message is based on the error message parameter.
Item [14] The error validation and navigation component according to Item [13], wherein the one or more navigation buttons are configured to move a user's focus between fields which belong to the form group identifier and the value of the error parameter for each field of the fields is true.
Item [15] At least one non-transitory computer-readable recording medium having recorded thereon instructions executable to implement a method including: receiving, by an error validation and navigation component, input data from a consumer component that is subscribed to the error validation and navigation component; evaluating, by the error validation and navigation component based on the input data, whether a field of the consumer component has an error or not; and sending, by the error validation and navigation component, a signal to the consumer component including instructions to render an error visualization component in the consumer component based on the evaluation and the input data, wherein the error visualization component includes a field highlighting component and a navigation bar component.
Item [16] The at least one non-transitory computer-readable recording medium according to Item [15], wherein the field highlighting component is configured to highlight each field which has an error and display an error message next to each field which has an error, and wherein the navigation bar includes a short summary describing how many errors there are, a detailed summary describing the status of all fields including which field has an error, and one or more navigation buttons, wherein the one or more navigation buttons are configured to move a user's focus between fields which have errors.
Item [17] The at least one non-transitory computer-readable recording medium according to any one of Items [15]-[16], wherein the input data is received each time a user's input is detected in the consumer component.
Item [18] The at least one non-transitory computer-readable recording medium according to any one of Items [15]-[17], wherein the input data further includes a rendering parameter which can either have a value of true or false, wherein if the value of the rendering parameter is false, the error visualization component is not rendered.
Item [19] The at least one non-transitory computer-readable recording medium according to Item [16], wherein the input data further includes form validation data and a form group identifier, wherein the field is selected based on the form validation data and the form group identifier, and wherein evaluating whether the field of the consumer component has an error or not is based on the form validation data.
Item [20] The at least one non-transitory computer-readable recording medium according to Item [19], wherein the form validation data includes a field identifier, a field name, an error parameter which can either have a value of true or false, and an error message parameter, wherein the field of the consumer component is one which matches the field identifier; wherein the field name is rendered in the detailed summary; wherein if the value of the error parameter is true, the field highlighting component is activated for the field and the status of the field in the detailed summary indicates there is an error; wherein if the value of the error parameter is false, the field highlighting component is deactivated for the field and the status of the field in the detailed summary indicates that there is no error; and wherein the displayed error message is based on the error message parameter.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method comprising:
receiving, by an error validation and navigation component, input data from a consumer component that is subscribed to the error validation and navigation component;
evaluating, by the error validation and navigation component based on the input data, whether a field of the consumer component has an error or not; and
sending, by the error validation and navigation component, a signal to the consumer component comprising instructions to render an error visualization component in the consumer component based on the evaluation and the input data, wherein the error visualization component includes a field highlighting component and a navigation bar component.

2. The method as claimed in claim 1, wherein the field highlighting component is configured to highlight each field which has an error and display an error message next to each field which has an error, and wherein the navigation bar comprises a short summary describing how many errors there are, a detailed summary describing the status of all fields including which field has an error, and one or more navigation buttons, wherein the one or more navigation buttons are configured to move a user's focus between fields which have errors.

3. The method as claimed in claim 1, wherein the input data is received each time a user's input is detected in the consumer component.

4. The method as claimed in claim 1, wherein the input data further comprises a rendering parameter which can either have a value of true or false,
wherein if the value of the rendering parameter is false, the error visualization component is not rendered.

5. The method as claimed in claim 2, wherein the input data further comprises form validation data and a form group identifier,
wherein the field is selected based on the form validation data and the form group identifier, and wherein evaluating whether the field of the consumer component has an error or not is based on the form validation data.

6. The method as claimed in claim 5, wherein the form validation data comprises a field identifier, a field name, an error parameter which can either have a value of true or false, and an error message parameter,
wherein the field of the consumer component is one which matches the field identifier;
wherein the field name is rendered in the detailed summary;
wherein if the value of the error parameter is true, the field highlighting component is activated for the field and the status of the field in the detailed summary indicates there is an error;
wherein if the value of the error parameter is false, the field highlighting component is deactivated for the field and the status of the field in the detailed summary indicates that there is no error; and
wherein the displayed error message is based on the error message parameter.

7. The method as claimed in claim 6, wherein the one or more navigation buttons are configured to move a user's focus between fields which belong to the form group identifier and the value of the error parameter for each field of the fields is true.

8. An error validation and navigation component configured to:
receive input data from a consumer component that is subscribed to the error validation and navigation component;
evaluate, based on the input data, whether a field of the consumer component has an error or not; and
send a signal to the consumer component comprising instructions to render an error visualization component in the consumer component based on the evaluation and the input data, wherein the error visualization component includes a field highlighting component and a navigation bar component.

9. The error validation and navigation component as claimed in claim 8, wherein the field highlighting component is configured to highlight each field which has an error and display an error message next to each field which has an error, and wherein the navigation bar comprises a short summary describing how many errors there are, a detailed summary describing the status of all fields including which field has an error, and one or more navigation buttons, wherein the one or more navigation buttons are configured to move a user's focus between fields which have errors.

10. The error validation and navigation component as claimed in claim 8, wherein the input data is received each time a user's input is detected in the consumer component.

11. The error validation and navigation component as claimed in claim 8, wherein the input data further comprises a rendering parameter which can either have a value of true or false, wherein if the value of the rendering parameter is false, the error visualization component is not rendered.

12. The error validation and navigation component as claimed in claim 9, wherein the input data further comprises form validation data and a form group identifier, wherein the field is selected based on the form validation data and the form group identifier, and wherein evaluating whether the field of the consumer component has an error or not is based on the form validation data.

13. The error validation and navigation component as claimed in claim 12, wherein the form validation data comprises a field identifier, a field name, an error parameter which can either have a value of true or false, and an error message parameter,
wherein the field of the consumer component is one which matches the field identifier;
wherein the field name is rendered in the detailed summary;
wherein if the value of the error parameter is true, the field highlighting component is activated for the field and the status of the field in the detailed summary indicates there is an error;
wherein if the value of the error parameter is false, the field highlighting component is deactivated for the field and the status of the field in the detailed summary indicates that there is no error; and
wherein the displayed error message is based on the error message parameter.

14. The error validation and navigation component as claimed in claim 13, wherein the one or more navigation buttons are configured to move a user's focus between fields which belong to the form group identifier and the value of the error parameter for each field of the fields is true.

15. At least one non-transitory computer-readable recording medium having recorded thereon instructions executable to implement a method comprising:
receiving, by an error validation and navigation component, input data from a consumer component that is subscribed to the error validation and navigation component;
evaluating, by the error validation and navigation component based on the input data, whether a field of the consumer component has an error or not; and
sending, by the error validation and navigation component, a signal to the consumer component comprising instructions to render an error visualization component in the consumer component based on the evaluation and the input data, wherein the error visualization component includes a field highlighting component and a navigation bar component.

16. The at least one non-transitory computer-readable recording medium as claimed in claim 15, wherein the field highlighting component is configured to highlight each field which has an error and display an error message next to each field which has an error, and wherein the navigation bar comprises a short summary describing how many errors there are, a detailed summary describing the status of all fields including which field has an error, and one or more navigation buttons, wherein the one or more navigation buttons are configured to move a user's focus between fields which have errors.

17. The at least one non-transitory computer-readable recording medium as claimed in claim 15, wherein the input data is received each time a user's input is detected in the consumer component.

18. The at least one non-transitory computer-readable recording medium as claimed in claim 15, wherein the input data further comprises a rendering parameter which can either have a value of true or false,
wherein if the value of the rendering parameter is false, the error visualization component is not rendered.

19. The at least one non-transitory computer-readable recording medium as claimed in claim 16, wherein the input data further comprises form validation data and a form group identifier, wherein the field is selected based on the form validation data and the form group identifier, and wherein evaluating whether the field of the consumer component has an error or not is based on the form validation data.

20. The at least one non-transitory computer-readable recording medium as claimed in claim 19, wherein the form validation data comprises a field identifier, a field name, an error parameter which can either have a value of true or false, and an error message parameter,
wherein the field of the consumer component is one which matches the field identifier;
wherein the field name is rendered in the detailed summary;
wherein if the value of the error parameter is true, the field highlighting component is activated for the field and the status of the field in the detailed summary indicates there is an error;
wherein if the value of the error parameter is false, the field highlighting component is deactivated for the field and the status of the field in the detailed summary indicates that there is no error; and
wherein the displayed error message is based on the error message parameter.
